(19) United States
(12) Patent Application Publication
(10) Pub. No.: US 2017/0286173 A1
(43) Pub. Date: Oct. 5, 2017

(54) METHOD, APPARATUS, AND COMPUTER PROGRAM PRODUCT FOR SCHEDULING RESOURCES

(71) Applicant: McKesson Corporation, San Francisco, CA (US)

(72) Inventors: Rakesh Wagh, Foster City, CA (US); Ajay Bhatnagar, Holly Springs, NC (US)

(21) Appl. No.: 15/084,183

(22) Filed: Mar. 29, 2016

(51) Int. Cl. G06F 9/50

(52) U.S. Cl. CPC G06F 9/5038

(57) ABSTRACT

A method, computing device and computer program product are provided to establish and maintain resource availability. Methods may include generating a representation of a resource availability schedule including at least one resource entry, where each resource entry includes a resource identification, a date, a location, a start time, and a finish time. Generating the representation may include: dividing the availability for each resource for each date and location into at least one continuous time period of availability, where no continuous time period of availability for a resource is represented by more than one resource entry; and generating a resource entry for each continuous time period. Methods may include: processing a request to schedule a resource, the request including a requested resource identifier, date, start time, finish time, and location; identifying a resource entry corresponding to the request; and modifying the resource entry to remove the time period of the request.

### TECHNOLOGICAL FIELD

An example embodiment of the present invention relates generally to scheduling resources, and more particularly, to an efficient method of scheduling resources that is less computationally intensive than conventional resource scheduling methods by using a pre-computed resource availability table having unique entries for available time periods.

### BACKGROUND

Computer-based schedule management of resources can provide indications of availability and scheduled events to users which can be advantageous when attempting to make an appointment with a resource. The availability of computer-based schedules has made scheduling of resources considerably more easy for users. However, scheduling of resources can be a complex process, particularly in environments with a plurality of requirements for the scheduling of an event. For example, scheduling a meeting with technological resource requirements may include determining availability for a particular meeting room (e.g., a room large enough to hold the attendees), determining availability for various technological equipment such as computers, televisions, projectors, etc., and determining availability for attendees. The schedule of availability for each of these resources (including physical requirements and attendees) can be complex and cumbersome. Further, scheduling such events may be computationally intensive, which can increase the cost to schedule events through the need for greater processing power, and can introduce undesirable latency in the scheduling process.

### BRIEF SUMMARY

A method, computing device and computer program product are provided according to an example embodiment in order to provide an efficient method of establishing resource availability and scheduling resources based on the availability. A computing device may be provided according to some embodiments having processing circuitry. The processing circuitry may be configured to: generate a representation of a resource availability schedule including at least one resource entry, where each resource entry may include a resource identification, a date, a location, a start time, and a finish time. The processing circuitry configured to generate the representation may include processing circuitry configured to: divide the availability of each resource for each date and location into at least one continuous time period of availability, where no continuous time period of availability for a resource is represented by more than one entry; and generate a resource entry for each continuous time period. The processing circuitry may further be configured to: process a request to schedule a resource, the request including a requested resource identifier, date, start time, finish time, and location; identify a resource entry corresponding to the request; and modify the resource entry to remove the time period of the request.

According to some embodiments, in response to a request to schedule a resource including a start time equating to the start time of the resource entry corresponding to the request, the processing circuitry configured to modify the resource entry may modify the resource entry start time to become the finish time of the request. In response to a request to schedule a resource having a finish time equating to the finish time of the resource entry corresponding to the request, the processing circuitry to modify the resource entry may modify the resource entry finish time to become the start time of the request. In response to a request to schedule a resource including a start time that does not equate to the start time of the resource entry corresponding to the request, and the request includes a finish time that does not equate to the finish time of the resource entry corresponding to the request, the processing circuitry configured to modify the resource entry may divide the resource entry corresponding to the request into a first resource entry and a second resource entry. The first resource entry may include a start time equating to the start time of the resource entry corresponding to the request and a finish time equating to the start time of the request. The second resource entry may have a start time equating to the finish time of the request and a finish time equating to the finish time of the resource entry corresponding to the request.

According to some embodiments, in response to a request to cancel a scheduled event for a resource, the computing device may optionally include processing circuitry configured to append a time period of the scheduled event to a resource entry for which the time period is continuous. The processing circuitry configured to process the request to schedule a resource may include processing circuitry configured to receive a request including a resource identification and at least one of a date range, a time duration, a time range, or acceptable locations, and the processing circuitry configured to process the request may include processing circuitry configured to establish available time periods corresponding to the request. The computing device may optionally include processing circuitry configured to: present the available time periods corresponding to the request; receive a selection from the available time periods; and process the selected request to schedule a resource for the selected time period.

Embodiments of the present invention may provide a method including: generating a representation of a resource availability schedule including at least one resource entry, where each resource entry includes a resource identification, a date, a location, a start time, and a finish time. Generating the representation may include: dividing the availability for each resource for each date and location into at least one continuous time period of availability, where no continuous time period of availability for a resource is represented by more than one resource entry; and generating a resource entry for each continuous time period. Methods may include: processing a request to schedule a resource, the request including a requested resource identifier, date, start time, finish time, and location; identifying a resource entry corresponding to the request; and modifying the resource entry to remove the time period of the request.

According to some embodiments, in response to a request to schedule a resource having a start time equating to the start time of the resource entry corresponding to the request, modifying the resource entry may include modifying the resource entry start time to become the finish time of the request. In response to a request to schedule a resource comprising a finish time equating to the finish time of the resource entry corresponding to the request, modifying the resource entry may include modifying the resource entry finish time to become the start time of the request. In response to a request to schedule a resource having a start time that does not equate to the start time of the resource entry corresponding to the request, and the request includes a finish time that does not equate to the finish time of the resource entry corresponding to the request, modifying the resource entry may include dividing the resource entry corresponding to the request into a first resource entry and a second resource entry. The first resource entry may include a start time equating to the start time of the resource entry corresponding to the request and a finish time equating to the start time of the request. The second resource entry may include a start time equating to the finish time of the request and a finish time equating to the finish time of the resource entry corresponding to the request.

According to some embodiments, in response to a request to cancel a scheduled event for a resource, methods may include appending a time period of the scheduled event to a resource entry for which the time period is continuous. Processing the request to schedule a resource may include receiving a request having a resource identification and at least one of a date range, a time duration, a time range, or acceptable locations, and processing the request may include establishing available time periods corresponding to the request. Methods may optionally include: causing presentation of the available time periods corresponding to the request; receiving a selection from the available time periods; and processing the selected request to schedule a resource for the selected time period.

Embodiments may provide a computer program product having a non-transitory computer-readable storage medium with program code portions stored therein. The program code portions may be configured, upon execution, to generate a representation of a resource availability schedule having at least one resource entry, where each resource entry includes a resource identification, a date, a location, a start time, and a finish time. The program code instructions to generate a representation may include program code instructions configured to: divide the availability for each resource for each date and location into at least one continuous time period of availability, where no continuous time period of availability for a resource is represented by more than one resource entry; and generate a resource entry for each continuous time period. The computer program product may optionally include program code portions configured to process a request to schedule a resource, the request including a requested resource identifier, date, start time, finish time, and location; identify a resource entry corresponding to the request; and modify the resource entry to remove the time period of the request.

According to some embodiments, in response to a request to schedule a resource having a start time equating to the start time of the resource entry corresponding to the request, the program code portions configured to modify the resource entry may include program code portions configured to modify the resource entry start time to become the finish time of the request. In response to a request to schedule a resource having a finish time equating to the finish time of the resource entry corresponding to the request, the program code instructions configured to modify the resource entry may include program code instructions configured to modify the resource entry finish time to become the start time of the request. In response to a request to schedule a resource having a start time that does not equate to the start time of the resource entry corresponding to the request, and the request includes a finish time that does not equate to the finish time of the resource entry corresponding to the request, the program code instructions configured to modify the resource entry may include program code instructions to divide the resource entry corresponding to the request into a first resource entry and a second resource entry. The first resource entry may include a start time equating to the start time of the resource entry corresponding to the request and a finish time equating to the start time of the request. The second resource entry may include a start time equating to the finish time of the request and a finish time equating to the finish time of the resource entry corresponding to the request.

According to some embodiments, in response to a request to cancel a scheduled event for a resource, the computer program product may optionally include program code instructions to append a time period of the scheduled event to a resource entry for which the time period is continuous. The program code instructions configured to process the request to schedule a resource may include program code instructions configured to receive a request having a resource identification and at least one of a date range, a time duration, a time range, or acceptable locations. The program code instructions configured to process the request may include program code instructions to establish available time periods corresponding to the request.

### BRIEF DESCRIPTION OF THE DRAWINGS

Having thus described certain example embodiments of the invention in general terms, reference will now be made to the accompanying drawings, which are not necessarily drawn to scale, and wherein:

FIG. 1 is a schematic representation of a system for scheduling resources that may be specifically configured in accordance with an example embodiment of the present invention;

FIG. 2 is a block diagram of a computing device that may be specifically configured in accordance with an example embodiment of the present invention;

FIG. 3 is an illustration of a portion of a resource availability schedule having multiple resource entries according to an example embodiment of the present invention;

FIG. 4 is an illustration of a portion of another resource availability schedule having multiple resource entries according to an example embodiment of the present invention;

FIG. 5 is an illustration of a portion of still another resource availability schedule having multiple resource entries according to an example embodiment of the present invention;

FIG. 6A illustrates a resource availability table or portion thereof according to an example embodiment of the present invention;

FIG. 6B illustrates a resource availability table or portion thereof after an appointment has been scheduled with a leading edge debit according to an example embodiment of the present invention;

FIG. 7A illustrates a resource availability table or portion thereof according to an example embodiment of the present invention;

FIG. 7B illustrates a resource availability table or portion thereof after an appointment has been scheduled with a trailing edge debit according to an example embodiment of the present invention;

FIG. 8A illustrates a resource availability table or portion thereof according to an example embodiment of the present invention;

FIG. 8B illustrates a resource availability table or portion thereof after an appointment has been scheduled with a complete slot debit according to an example embodiment of the present invention;

FIG. 9 is an illustration of a portion of a resource availability schedule having multiple resource entries according to an example embodiment of the present invention;

FIG. 10A illustrates a resource availability table or portion thereof according to an example embodiment of the present invention;

FIG. 10B illustrates a resource availability table or portion thereof after an appointment has been canceled with a leading edge credit according to an example embodiment of the present invention;

FIG. 11 illustrates a user interface for scheduling appointments according to an example embodiment of the present invention; and

FIG. 12 is a flowchart of a method employed for establishing and maintaining resource availability according to an example embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

A method, computing device and computer program product are provided in accordance with an example embodiment in order to more efficiently schedule resources with lower computational intensity and less latency due to an improved data structure for maintaining resource availability. In this regard, the method, computing device, and computer program product of an example embodiment may be configured to provide scheduling for virtually any type of resource, such as scheduling for meetings, home contractor appointments, medical appointments, etc.

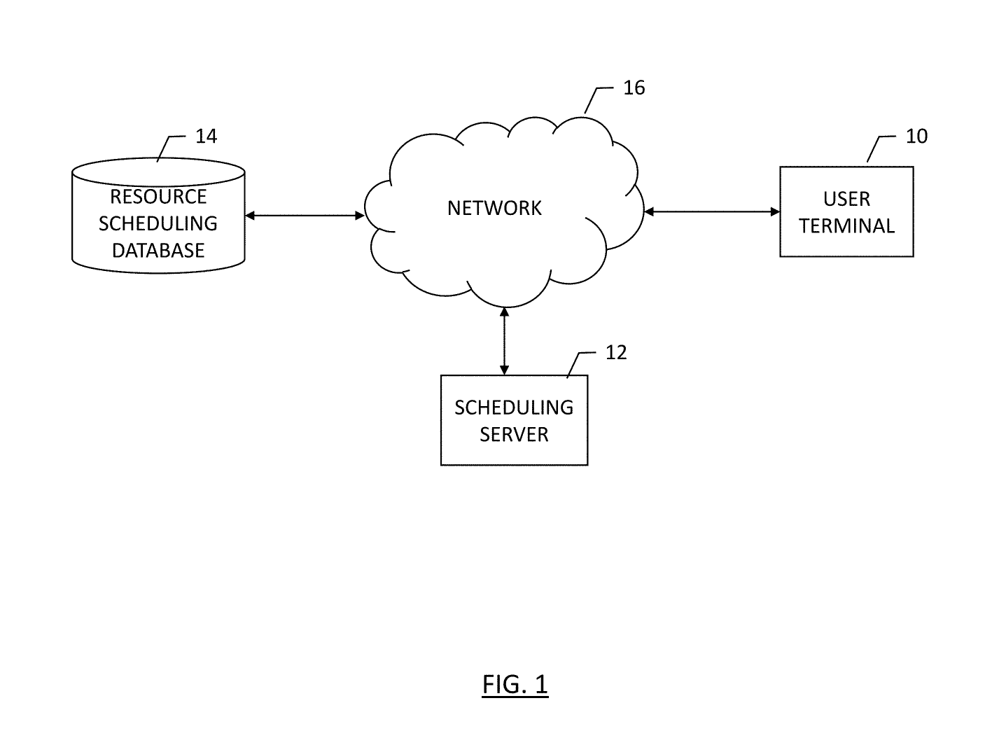

Scheduling of resources is a common issue encountered frequently in various environments. An individual may need to schedule an appointment at a medical facility, a service call with a service technician or appliance repair technician, or a meeting with participants and technological resources, for example. This scheduling may be performed through a computer interface over a network. FIG. 1 illustrates an example system diagram in which a device, such as a user terminal 10, may be used for scheduling a resource in an example communication environment. As shown in FIG. 1, an embodiment of a system in accordance with an example embodiment of the present invention may include a user terminal 10, a scheduling server 12, and a resource scheduling database 14, each capable of communicating with one another via network 16.

The network 16 may include a collection of various different devices (such as user terminal 10 or server 12) that may be in communication with one another via corresponding wired and/or wireless interfaces. As such, the illustration of FIG. 1 should be understood to be an example of a broad view of certain elements of the system and not an all-inclusive or detailed view of the system or the network 30.

The resource scheduling database 14 may be configured to store scheduling availability information for a plurality of resources as described below, and may be in communication with the scheduling server 12 for establishing resource availability and for processing requests to schedule a resource from among the plurality of resources in an efficient manner. While the resource scheduling database 14 and the scheduling server 12 are depicted as separate entities, the scheduling server and resource scheduling database may be embodied as a single entity. Further, the resource scheduling database 14 and scheduling server 12 may be configured as a self-contained scheduling system in which no network communication is necessary to impart embodiments of the invention described herein.

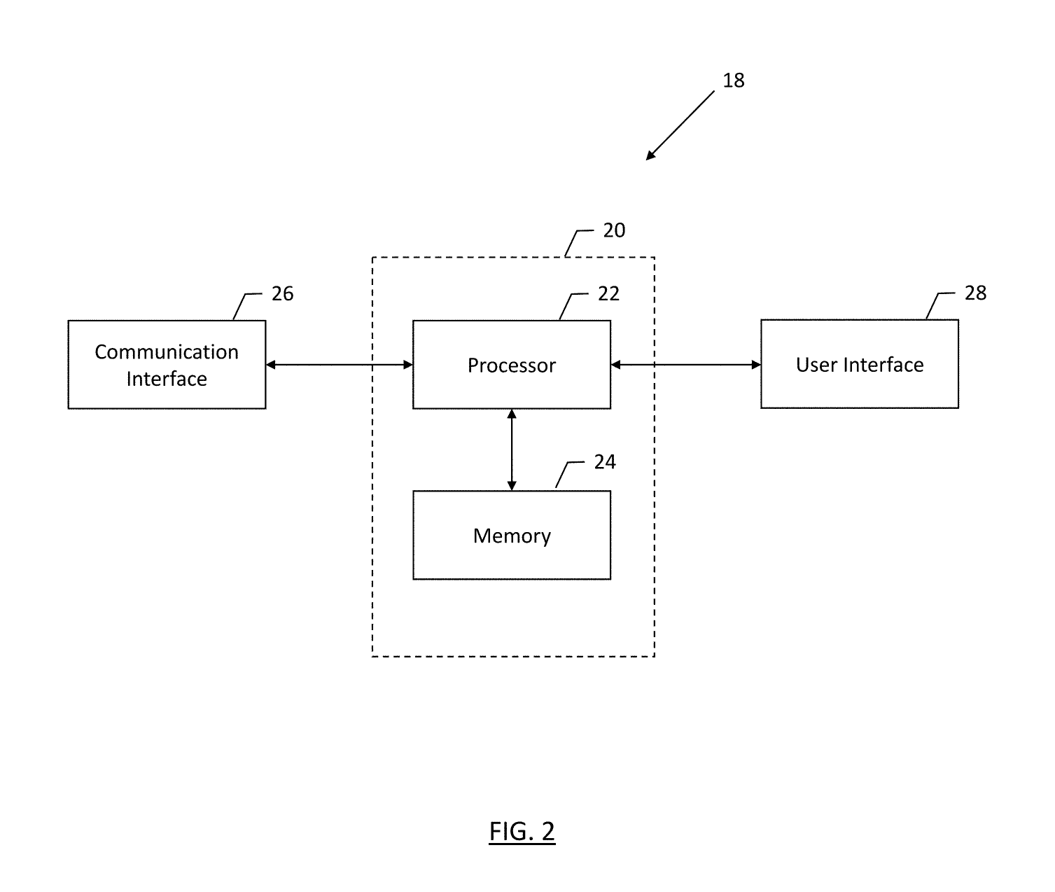

FIG. 2 illustrates a block diagram of a computing device 18 in accordance with some example embodiments. The computing device 18 may embody the user terminal 10 or the scheduling server 12, and may be capable of functioning in a variety of different scheduling infrastructures for handling the scheduling of resources. The computing device 18 may be embodied by one or more servers (e.g., scheduling server 12), computer workstations, tablet computers, desktop or laptop computers, or the like. As described below, the computing device may be configured to implement and/or otherwise support implementation of various example embodiments of the present invention. However, it should be noted that the components, devices, or elements illustrated and described with respect to FIG. 2 may not be mandatory, and thus some may be omitted in certain embodiments. Additionally, some embodiments may include further or different components, devices, or elements beyond those illustrated in and described with respect to FIG. 2.

The computing device 18 may include or otherwise be in communication with processing circuitry 20 that is configurable to perform actions in accordance with one or more example embodiments disclosed herein. In this regard, the processing circuitry may be configured to perform and/or control performance of one or more functionalities of the computing device in accordance with various example embodiments, and thus may provide means for performing functionalities of the computing device. The processing circuitry may be configured to perform data processing, application execution and/or other processing and management services according to one or more example embodiments.

In some example embodiments, the processing circuitry 20 may include a processor 22 and, in some embodiments, such as that illustrated in FIG. 2, may further include memory 24. The processing circuitry may be in communication with or otherwise control a communication interface 26 and, in some embodiments, a user interface 28. As such, the processing circuitry 20 may be embodied as a circuit chip (e.g., an integrated circuit chip) configured (e.g., with hardware, software or a combination of hardware and software) to perform operations described herein.

The processing circuitry 20 may be embodied in a number of different ways. For example, the processing circuitry 20 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processing circuitry 20 may be configured to execute instructions stored in the memory 24 or otherwise accessible to the processing circuitry 20. As such, whether configured by hardware or software methods, or by a combination thereof, the processing circuitry 20 may represent an entity (e.g., physically embodied in circuitry) capable of performing operations according to embodiments of the present invention while configured accordingly. Thus, for example, when the processing circuitry 20 is embodied as an ASIC, FPGA or the like, the processing circuitry 20 may be specifically configured hardware for conducting the operations described herein. Alternatively, as another example, when the processing circuitry 20 is embodied as an executor of software instructions, the instructions may specifically configure the processing circuitry 20 to perform the operations described herein.

In an example embodiment, the memory 24 may include one or more non-transitory memory devices such as, for example, volatile and/or non-volatile memory that may be either fixed or removable. The memory 24 may be configured to store information, data, applications, instructions or the like for enabling the apparatus to carry out various functions in accordance with example embodiments of the present invention. For example, the memory 24 could be configured to buffer input data for processing by the processing circuitry 20. Additionally or alternatively, the memory 24 could be configured to store instructions for execution by the processing circuitry 20. As yet another alternative, the memory 24 may include one of a plurality of databases that may store a variety of files, records, contents or data sets. Among the contents of the memory 24, applications may be stored for execution by the processing circuitry in order to carry out the functionality associated with each respective application.

The user interface 28 may be in communication with the processing circuitry 20 to receive an indication of a user input at the user interface and/or to provide an audible, visual, mechanical or other output to the user. As such, the user interface may include, for example, a keyboard, a mouse, a joystick, a display, a touch screen display, a microphone, and/or other input/output mechanisms. In embodiments in which the computing device 18 is implemented on a server, aspects of the user interface may be limited, or the user interface may even be eliminated. For example, the computing device may act as a server or host device, with a user interface provided by a client application.

The computing device 18 may include one or more communication interfaces 26 for enabling communication with other devices and/or networks. In some cases, the communication interface 26 may be any means such as a device or circuitry embodied in either hardware, or a combination of hardware and software that is configured to receive and/or transmit data from/to a network and/or any other device or module in communication with the processing circuitry. In this regard, the communications interface 26 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

Having now described computing device 18 configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

Embodiments of the present invention may include methods, computing devices, and computer program products for scheduling resources, and more particularly, to an efficient method of scheduling resources that is less computationally intensive than conventional resource scheduling methods by using a schedule availability table having unique entries for available time periods.

It is desirable for the availability of schedulable resources to be determined in an efficient manner in order to provide schedule suggestions to a user attempting to schedule the resource and to accurately maintain resource availability in substantially real-time. The resource may have availability at specific locations, dates, and times, and these elements of resource availability may add further complexity to the scheduling process that can influence the computational intensity of scheduling an event with the resource. While a resource may be any individual, group, location, device, or the like, embodiments described herein may generally reference the resource as an individual, such as a medical professional, where the scheduling comprises patients scheduling appointments with the resource. It is understood, however, that the resource could be a meeting room, a hospital room or bed, an apparatus such as a magnetic resonance imaging (MRI) machine, an X-ray machine, a chemo chair, a tanning bed, a vehicle (e.g., in car or ride-sharing applications), a service technician, a therapy provider, etc. As such, the example embodiments described herein are provided merely as an example and embodiments of the present invention may be applied to various other resources as would be apparent to one of ordinary skill in the art.

The availability of a resource may depend on various factors such as in the case of a person, the resource's calendar (e.g., the days and time periods available for scheduling, for instance weekdays 9 a.m. to 5 p.m.), and time slots that have already been committed to other appointments or time slots that are unavailable (e.g., a lunch hour). Computing availability using “on the fly” or “just in time” algorithms may be computationally intensive having a relatively high expense and may lead to performance and scalability issues for an application. According to example embodiments provided herein, resource availability may be pre-calculated for a period of time, such as for a year into the future. The example embodiments described herein enable efficient delivery of resource availability data and improves the performance and scalability of the scheduling application.

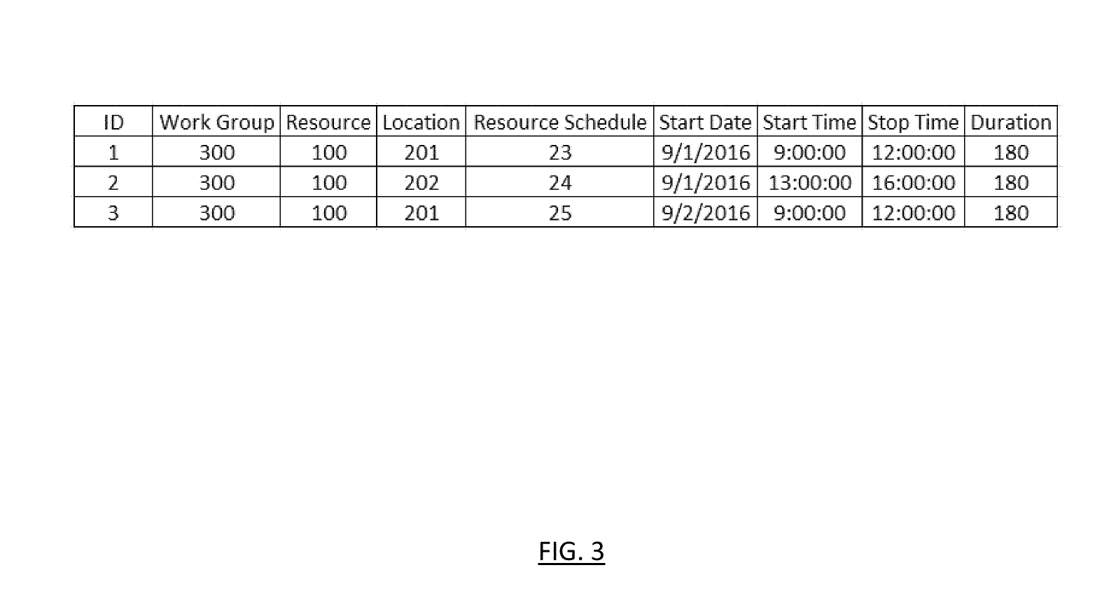

According to an example embodiment, a table is generated to reflect resource availability for a look-ahead time window, and the table is stored in a database such as resource scheduling database 14. FIG. 3 is an example embodiment of a resource availability table indicating the availability of a resource. While the depicted table illustrates a single resource, additional resources may be depicted within the same table. The table includes an identification or “ID” as shown in FIG. 3, which provides a unique identifier of the table row, where each row represents a period of time for a particular resource. The table of FIG. 3 further includes a “Work Group” identifier, which may be indicative of a group to which the resource belongs as described further below. The table shown includes a column identifying the resource, a column identifying a location of the resource for the time period represented by the row, a date or “Start Date” for the time period represented by the row, and start and stop times for the respective time period. A “Resource Schedule” column may be provided to indicate the schedule of the resource, particularly when a resource is on a recurring schedule where the Resource Schedule column can identify the recurring schedule. For example, a doctor may be at practice A from 9 a.m. through noon and practice B from 1 p.m. through 4 p.m. on all weekdays for the next six months. These details may be captured in a resource schedule table in the database in which the resource availability is stored, such as in memory 24, while the value in the Resource Schedule column may be a reference, for example, to a line of the table in the database.

According to some embodiments, a duration may also be included as shown indicating a duration of the time period represented by each row in minutes. This duration column may be calculated at the resource availability table to be the Start Time subtracted from the Stop Time, and may be included as an optimization to avoid having to compute the duration during runtime as schedule availability is assessed. This enables simplified filtering if a user is looking for an available time slot that is of a minimum duration, such as 60 minutes. Various other fields can optionally be included. For example, a new patient field can be included providing an indication of whether the entry is available for scheduling of new patients. Similarly columns can be included for “Follow Up” to indicate if the entry in the resource availability table is available for Follow Up appointments. The number and type of column available may be configured to accommodate the particular implementation of the resource availability table. For example, if the resource availability was for an auto mechanic shop, certain entries of the resource availability table may be reserved exclusively for warranty work, for oil changes, for recall work, etc. As such, the columns available for filtering may be determined based on the implementation, and may be configured, for example, by a system operator.

The table of example embodiments described herein may be generated in response to receipt of a schedule of availability of a resource, where the table is built from the information received. For example, if a resource schedule is received that indicates the resource is available Monday through Friday, from 8 a.m. to 4 p.m., for the next four weeks, a table may be generated with a row for each weekday for the next four weeks, each row indicating the respective date, the start time, the finish time, and the resource identification. This generation of the resource availability table may be performed when a schedule is received or updated, and the table may be pre-computed based on the availability of a resource. Said differently, the resource availability table may be generated in advance of users trying to schedule available resources, and the table may be updated only as appointments are scheduled, resource availability changes (e.g., vacation time requests), equipment maintenance is scheduled, or the like. The initial creation of the resource availability table may take place exclusive of the scheduling of resources in order to minimize the computational complexity of scheduling resources.

According to example embodiments, each row or entry of the table represents a continuous, unbroken period of time for a particular resource. No two resources or elements that can be scheduled separately would be represented by the same entry, and no entry would represent a non-continuous period of time. Each continuous, unbroken period of time for each resource/location combination is represented by only a single entry, and no two entries are immediately adjacent to one another in time. For example, an entry for availability from 3:00 p.m. to 5:00 p.m. would not be represented by two entries of 3:00 p.m. to 4:00 p.m. and 4:00 p.m. to 5:00 p.m. The row of the table of FIG. 3 having an ID of 1 is associated with the time period of 9:00 a.m. until 12:00 p.m. on Sep. 1, 2016, where resource “100” is scheduled to be available. The resource may be, for example, a person such as a doctor. The location may be a physical location where the resource will be during the time period of the row, such as a specific medical practice or hospital unit, for example. The table of FIG. 3 is a partial representation of a table that may be stored in the resource scheduling database 14 as the table may cover an extended time period, such as a year into the future.

According to some example embodiments, multiple resources may be represented within a single table stored, for example, in resource scheduling database 14. A work group, such as work group 300 of FIG. 3, may have multiple resources associated therewith, and the availability of each of those resources may be represented in the table. The work group may be representative of resources having the same capabilities. For example, the resources may be physicians or medical professionals, while the work group may include a certain specialty. A work group may include a plurality of radiologists, for example. A person scheduling an appointment with a radiologist may not have a preference for a particular technician, such that the appointment may be scheduled according to the work group instead of a specific resource. Further, in the event the resource availability schedule table grows too large to be managed efficiently, the resource availability schedule table may be broken into multiple resource availability schedule tables, where the tables may be separated based on the work groups of each entry.

A user interface, such as user interface 28 of client terminal 10, may be used to schedule a resource for an activity or event via processing circuitry 20. In an instance in which the resource is a medical professional, the user may request availability for a resource for a particular time window. The user interface may enable the user to select one or more of a specific date, a specific time of day, a specific location, etc. The user selections of the user interface may be used to quickly reference a table, such as the table of FIG. 3, to indicate the availability of the resource for the specified criteria. Optionally, if a user's specific criteria cannot be met (i.e., the resource is unavailable for the selected date, time, or location), a recommendation may be made to the user of a resource availability time approximating the user's criteria. The logic for recommending a time, date, and location of an event or appointment may include weighting the user input criteria according to a weight described by the patient (e.g., appointment must be after 3 p.m.), or according to a difficulty of scheduling assessment based on the resource availability.

The user interface for scheduling may be configured to limit or filter resource availability by any information available within the resource availability table. For example, if a user provides only a physician name, and does not specify any location or time, the resource availability table may be referenced for the first available entry for that physician. Alternatively, if a user selects a location, an appointment type (e.g., a specific medical procedure), and a time range (e.g., afternoon), the resource availability table may be filtered for the available entries corresponding to the location, appointment type, and time of day. Any available fields may be used to help schedule resources and to facilitate a user interface to more easily determine resource availability that meets the needs of a user.

According to some embodiments, resource availability may be updated as a user selects different limiting criteria in real-time such that a user may add and remove limiting criteria to visually recognize what resource options may be made available or made unavailable through the selection of various criteria. In an example, a user may select a date for an appointment with a physician, and they may also choose a location. The available physicians may be presented to the user such that they could further filter the available appointments by physician. Alternatively, the user may see the list of physicians, but may enter a criteria of “new patient” to see which of the available physicians at the specified location on the specified date are also available to see a new patient. Users can select as many or as few criterion as are available in the user interface in order to narrow or broaden a search according to their specific needs.

Once a user has been provided with one or more options for a time, date, and location for scheduling the event or appointment, the user may select the desired time, date, and location. Once the event is selected, methods of example embodiments provided herein may remove the scheduled time from the availability of the resource.

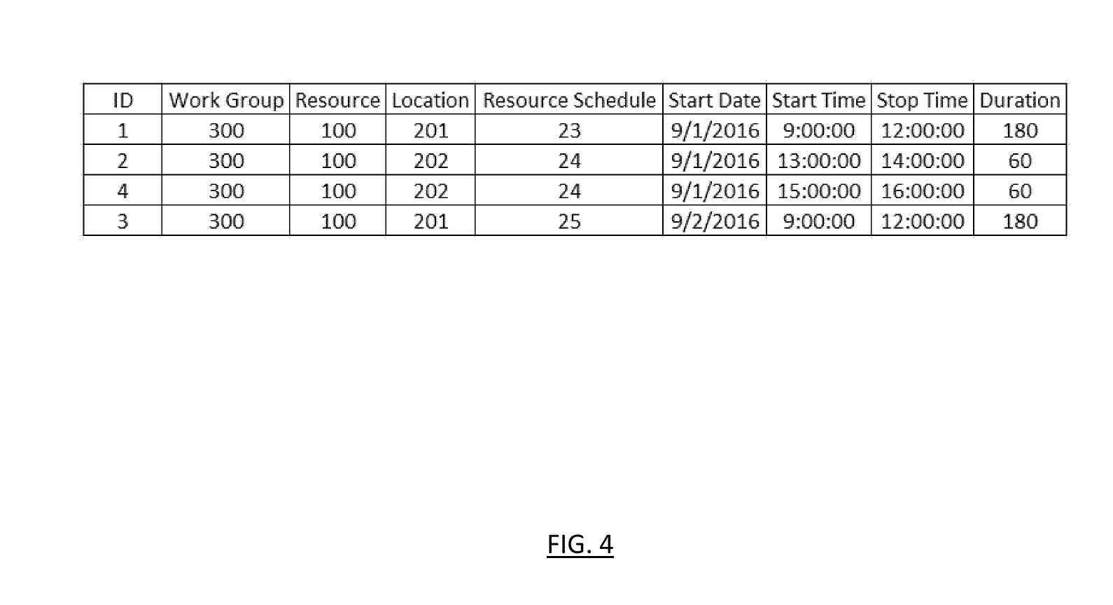

According to an example embodiment provided herein, with reference to the table of FIG. 3, a user may request an appointment on Sep. 1, 2016, at 2:00 p.m. (or 14:00 in 24-hour time) with a duration of one hour (i.e., until 15:00). FIG. 4 illustrates the resultant resource availability table. As shown, the row corresponding to the time period of 13:00:00 to 16:00:00 on Sep. 1, 2016, corresponding to ID 2 has been fragmented into two different rows, with the period between 14:00:00 and 15:00:00 no longer appearing in the table. Fragmentation in this case is necessary as no entry in the table matched the start or finish time of the requested appointment, such that this is considered a “no-edge” debit. As each row represents a continuous time period, the time period between 13:00:00 and 16:00:00 without the period of 14:00:00 and 15:00:00 could not be represented in a single row or single resource entry, and must be fragmented to reflect the removal of the availability of the scheduled appointment.

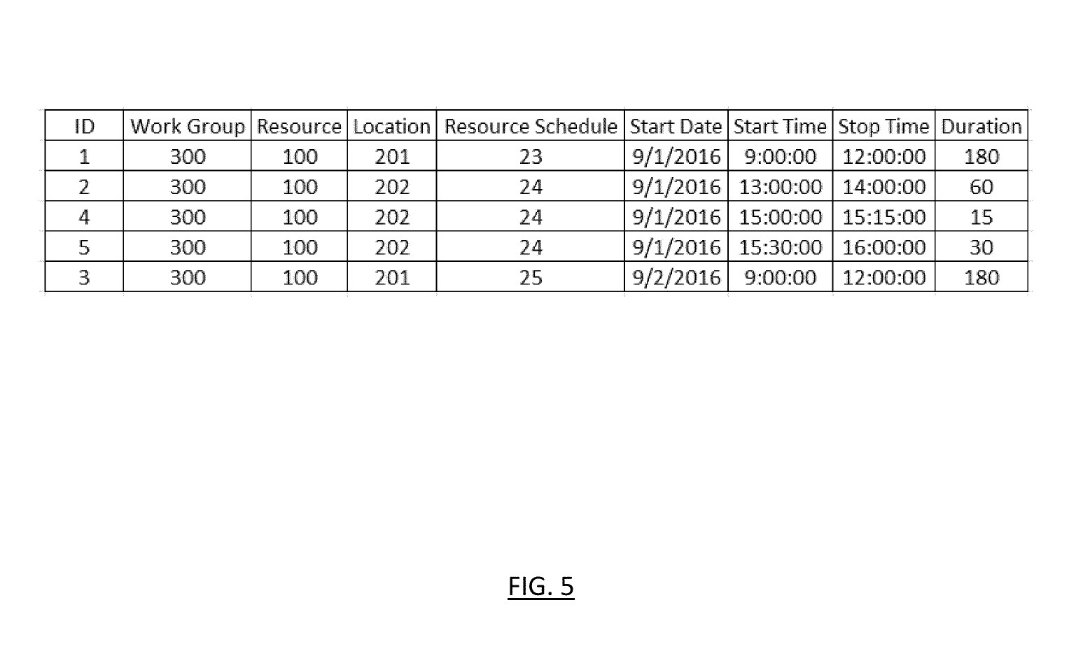

FIG. 5 illustrates the example embodiment of FIG. 4; however, an additional event has been scheduled. The time period of 15:15:00 to 15:30:00 for resource 100 has been scheduled for Sep. 1, 2016 responsive to a request to schedule the resource. In response, the row representing time period 15:00:00 to 16:00:00 has been fragmented into two rows including the time period from 15:00:00 to 15:15:00 and 15:30:00 to 16:00:00. The duration of each of these time periods has also been updated. Again, this fragmentation is required since the new appointment scheduled did not have a start time corresponding to a start time of an entry of the requested resource, and the stop time did not correspond to a stop time of the requested resource. This no-edge debit results in a fragmentation of one resource availability entry into two resource availability entries.

If an appointment is requested with a start time that matches a start time of an available entry, the entry may not be fragmented, but instead the entry may have the start time changed from the original start time (corresponding to the appointment request) to the end time of the appointment request, as the appointment has removed a portion at the beginning of the entry from the availability table. Similarly, if an appointment is requested that has a stop time corresponding to the stop time of an entry, and the start time is not the start time of the entry, the entry may be revised to have the original start time, but the stop time would become the start time of the new appointment request.

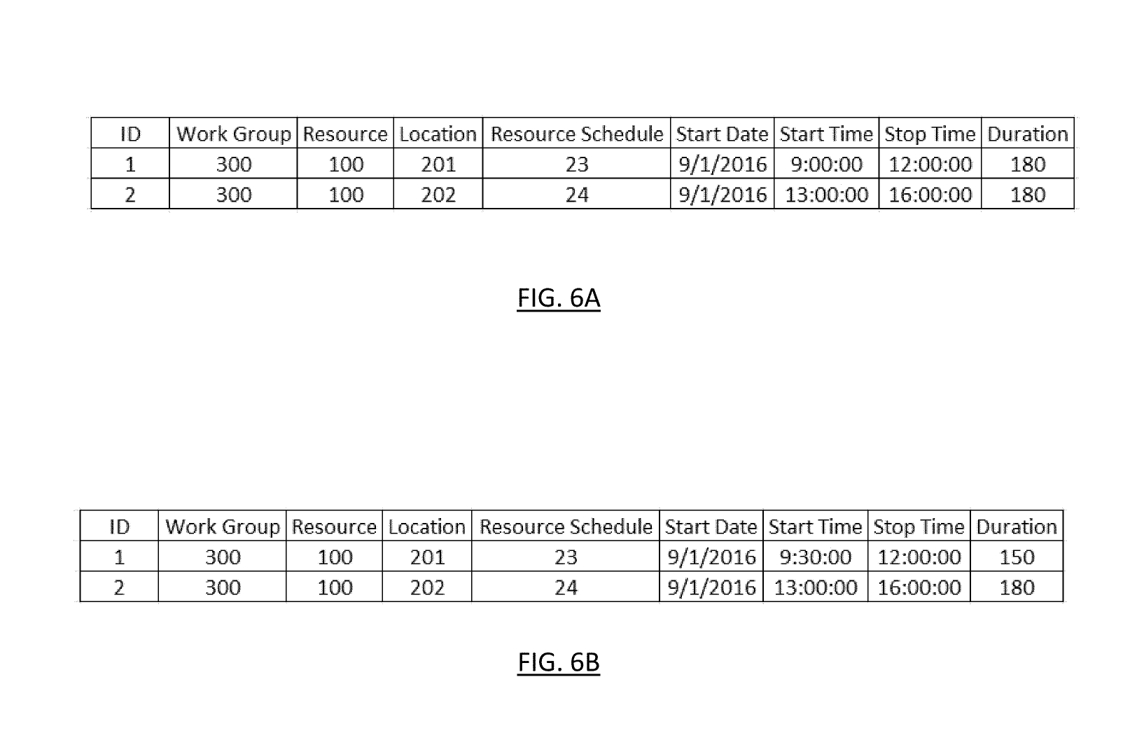

According to an example embodiment described herein, a leading edge debit of an available resource may be performed in response to the start time of an appointment request matching the start time of an entry in the resource availability table. FIG. 6A illustrates a resource availability table or a portion thereof before scheduling of an appointment. As shown, two entries exist for resource 100, including one at location 201 and one at location 202. An appointment request includes a start time of 9:00 and a stop time of 9:30 of Resource 100 at Location 201 on Sep. 1, 2016. FIG. 6B illustrates the resource availability table in response to scheduling the appointment request, where the leading edge debit is taken and the 30 minute appointment has been removed from the resource availability table. The new start time of the availability entry is 9:30, the stop time of the scheduled appointment, and the duration has commensurately been reduced.

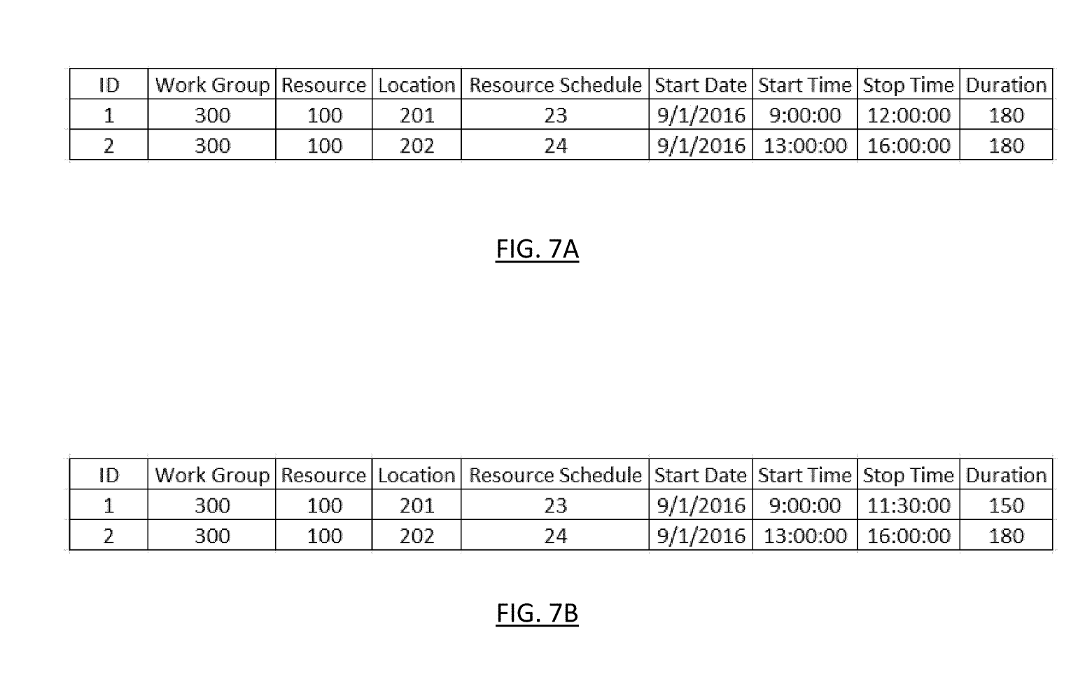

Another example embodiment described herein is a trailing edge debit of an available resource performed in response to scheduling of an appointment having a stop time aligning with a stop time of a resource availability entry. FIG. 7A illustrates a resource availability table or portion thereof including two entries: one having Resource 100 at Location 201 and the other having Resource 100 at Location 202. An appointment request for Resource 100 at Location 201 includes a start time of 11:30 and a stop time of 12:00, corresponding to stop time of the first entry of FIG. 7A. FIG. 7B illustrates the appointment scheduled where the availability entry for Resource 100 at location 201 on Sep. 1, 2016 has been changed to reflect a stop time equating to the start time of the appointment request, and the duration reduced by the 30 minutes of the scheduled appointment.

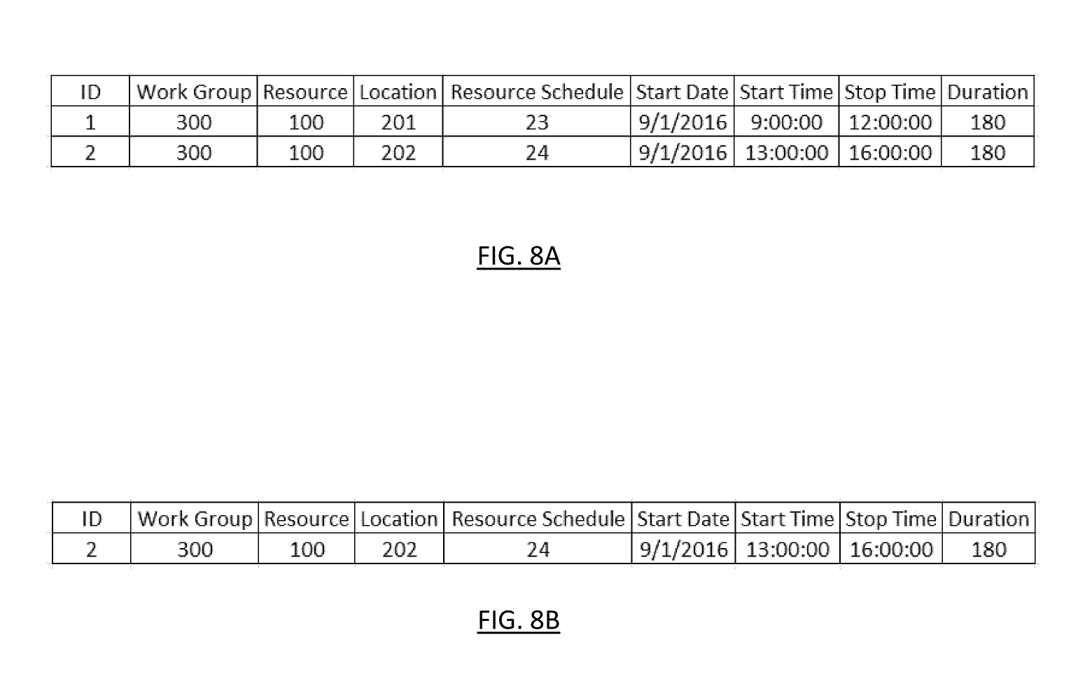

A complete time slot debit of an available resource performed in response to the scheduling of an appointment is illustrated in FIGS. 8A and 8B. As shown, a resource availability table or portion thereof is shown in FIG. 8A including two entries: one having Resource 100 at Location 201 and the other having Resource 100 at Location 202. An appointment request is received for Resource 100 having a start time of 9:00 and a stop time of 12:00. The start time of the request and the stop time of the request correspond identically with the start time and stop time of the entry. As such, the entry is entirely booked by the requested appointment. FIG. 8B illustrates the portion of the availability table after the appointment has been scheduled, where Resource 100 is no longer available from 9:00 to 12:00.

The duration may be used for scheduling purposes in the event a user wants to find an appointment available on a particular day or a next-available appointment where the appointment duration is 60 minutes. As shown in FIG. 4, rows corresponding to ID 4 and 5 would not be recommended since they cannot satisfy the duration requirement. Maintaining a duration column enables faster searches for appointments based on the duration of the appointment without requiring the availability duration windows to be calculated separately for each row as a search is conducted, thereby further reducing latency.

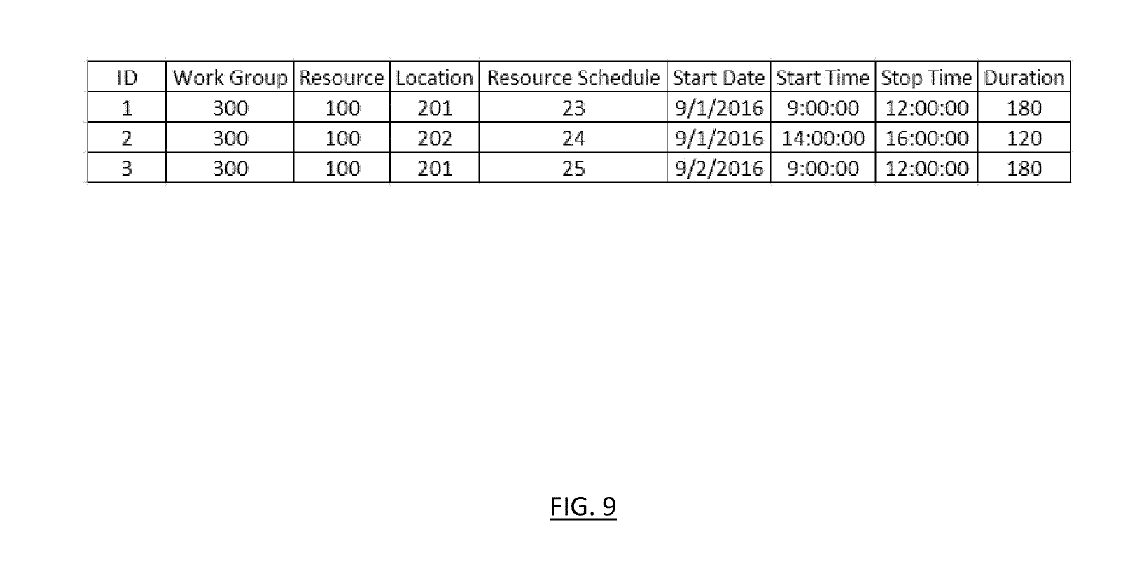

FIG. 9 illustrates an example embodiment of the resource availability table of FIG. 3 that would be generated in response to a request to schedule an appointment with resource 100 between 13:00:00 and 14:00:00. This is another example of a “leading edge” debit where the start time of the requested appointment matches the start time of the requested resource availability entry. As shown, since the period from 14:00:00 to 16:00:00 is continuous, the row does not need to be fragmented. However, the period of time from 13:00:00 to 14:00:00 has been removed from the availability table, and the duration of time of the row has been updated accordingly.

Representing and storing resource availability in the tables, such as in a resource scheduling database 14, as shown and described herein enable resource availability to be determined in real time without requiring a user interface to be altered. Further, the table only reflects time periods that are available for a resource and does not maintain a list of appointments or events, or the details associated with a scheduled event. In this manner, the resource availability table is a lean storage format that enables large amounts of resource availability information to be stored and accessed with minimal processing and minimal latency. The resource availability tables as described herein are also scalable to any number of resources and any number of events. Tables representing resource availability may be fragmented into multiple tables should the tables become unmanageable or if processing capabilities may benefit from such fragmentation. Fragmentation may be performed, for example, according to the work group of the resources.

According to an example embodiment of scheduling resources in a healthcare environment, the work groups may correspond to practice areas. Tables may include hundreds of resources and thousands of resource availability time periods represented by rows. Should a table become too large to efficiently manage, the table may be broken up by practice. For example, the practice of radiology may be fragmented to a separate table, or grouped with another practice into a new table.

As resource availability may change periodically, periods of time may become scheduled with events or appointments, while other events or appointments may be canceled. In an example embodiment in which an appointment or event is canceled, the period of time that was scheduled for that appointment or event may be added back into the resource availability table. A row of the table may be revised if the period of time previously scheduled for the appointment or event is continuous with an existing time period represented in a row. Alternatively, a new row may be created in an instance in which the period of time previously scheduled for the appointment or event is not adjacent to or continuous with an existing available period of time for the resource. If the canceled appointment falls between two resource entries in the table with no other time periods between the two resource entries, the two resource entries may be combined or re-combined to form a single entry representative of the now continuous period of time available. In this manner, periods of time may be debited or credited to a table of resource availability based on whether it becomes scheduled time or if the time becomes available.

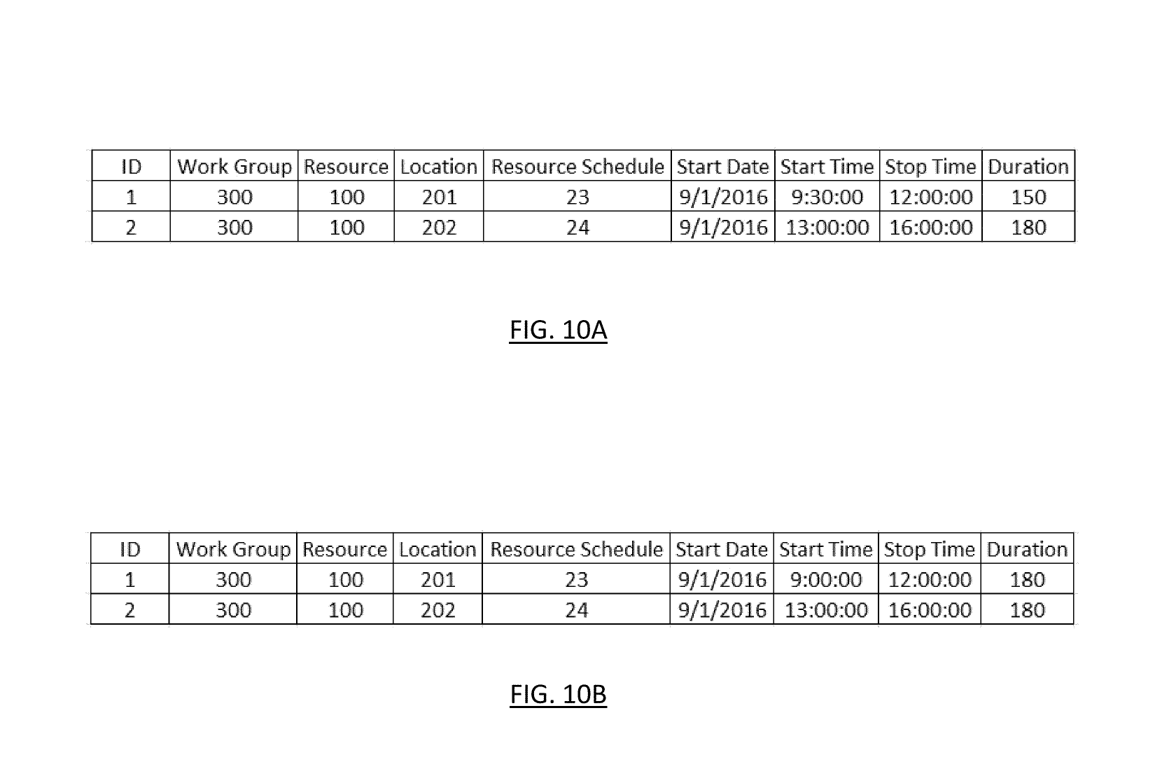

FIG. 10A illustrates a resource availability table or portion thereof including two entries: one for Resource 100 at Location 201 from 9:30 to 12:00; and one for Resource 100 at Location 202 from 13:00 to 16:00. The time for Resource 100 at Location 201 from 9:00 to 9:30 may not have been previously available to schedule (e.g., the resource's schedule started at 9:30) or the time slot may have been booked for an appointment. In response to an appointment scheduled from 9:00 to 9:30 being canceled, or the resource's schedule otherwise opening up to availability from 9:00 to 9:30, the time may be credited to the resource availability entry in a leading edge credit. FIG. 10B illustrates the resource availability entry where the time from 9:00 to 9:30 for Resource 100 has been added into the resource availability entry.

The table of availability for a resource may represent a window of time into the future. This window of time may vary depending on the environment in which the resource scheduling tool is implemented. In some embodiments, a window of time may be a year, while in other embodiments, the window of time may be a matter of days. Regardless, this window of time may be persistently advancing as time passes. The window of availability may be advanced incrementally throughout a day, such as every hour, or the window of availability may be advanced on a daily or weekly basis.

As the window of time represented by the table advances, the availability of a resource that exists in the past may be purged from the system. In this manner, the table may be trimmed and remain a manageable size. The purging of availability in the past may be performed throughout a day, such as on an hourly basis, or the purging of availability in the past may be performed on a daily, or weekly basis.

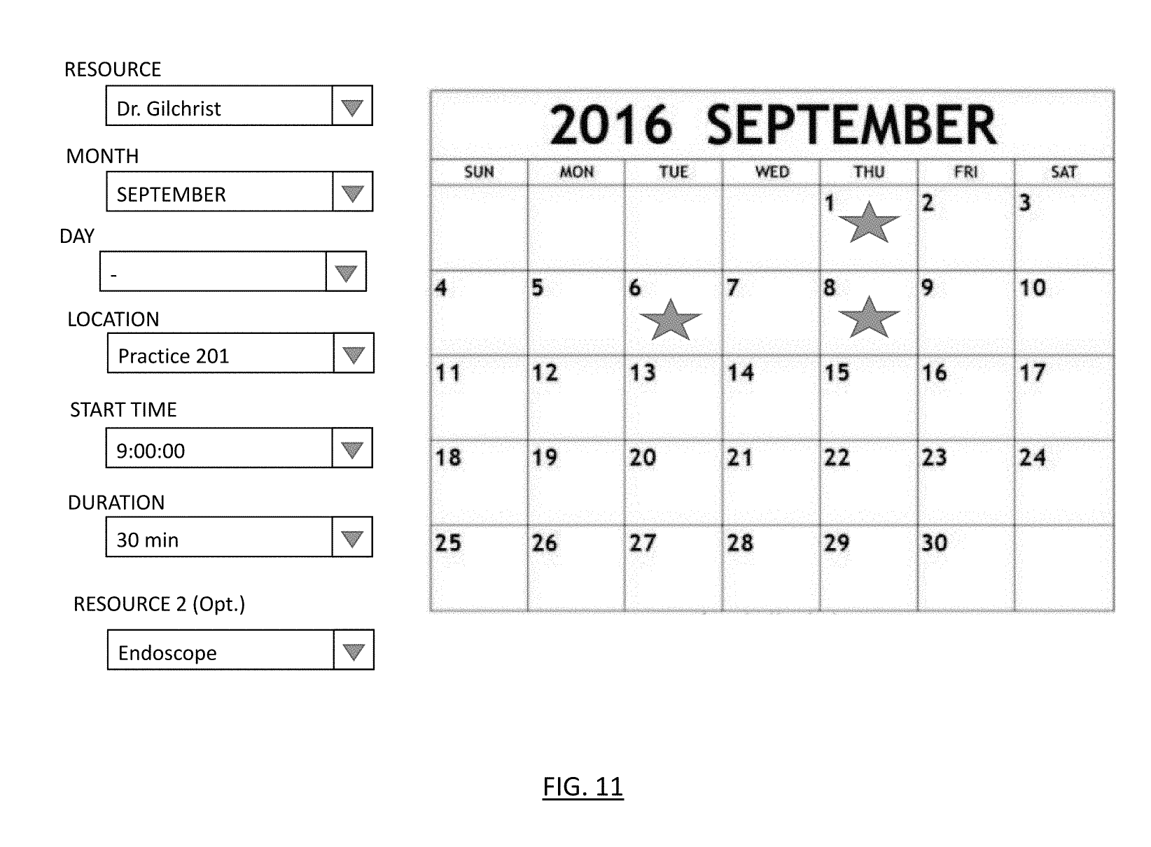

According to some embodiments, multiple resources may be required for certain appointments. For example, a user may wish to schedule an appointment with a physician for a particular procedure requiring a specific medical tool (e.g., endoscope, X-ray machine, etc.). The user may need to schedule both the physician and the tool as they are both required resources for the desired appointment. The user interface may include options available for date, time, but may also have options available for a first resource to be selected. FIG. 11 illustrates an example user interface (e.g., user interface 28), in which a number of options are available for user selection, including the resource, month, day, location, start time, duration, and an optional second resource. As shown, the user has selected a resource, a month, location, start time, duration, and second resource. The day has been left open. The calendar may depict dates meeting the selected criteria such that a user can select their preferred date. Additional or fewer options may be available for user selection depending upon the configuration, and the availability view may be provided in any manner suitable to convey the necessary information.

According to some embodiments, the resources required for certain appointments may be determined according to information entered by a user. For example, if a user schedules an appointment with a resource (i.e., a physician) and selects an appointment type of MRI (magnetic resonance imaging) session, the availability of the resource may automatically take into consideration the necessity for the availability of an MM machine at the same time. Similarly, if a user schedules an appointment with a certain type of resource that has additional resource requirements, such as scheduling an appointment with a radiologist, where the radiologist requires an X-ray machine to conduct the appointment, the X-ray machine resource availability may be considered in determining the availability of the radiologist resource. Such automatic association between a resource or a request type with additional resources may ensure the proper resources are available for a user scheduling an appointment.

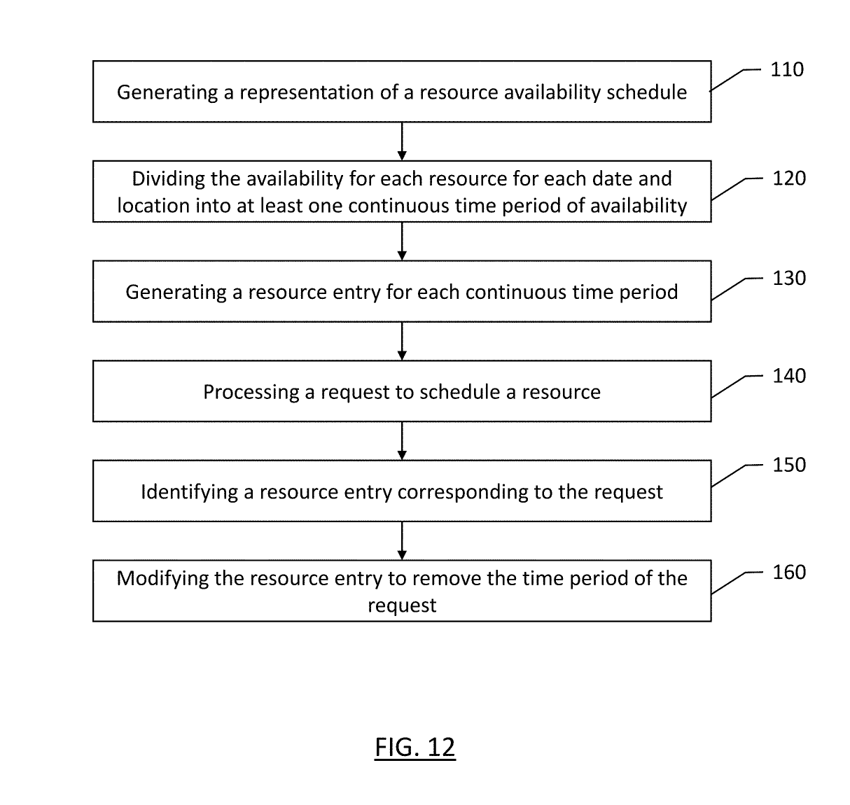

FIG. 12 is a flowchart illustrating a method for facilitating the scheduling of resources according to an example embodiment of the present invention. As illustrated in element 110, a representation of a resource availability schedule may be generated, for example, by processing circuitry 20, where each resource entry includes a resource identification, a date, a location, a start time, and a finish time. Generating the representation may include dividing the availability for each resource for each date and location into at least one continuous time period of availability, where no continuous time period of availability for a resource is represented by more than one resource entry as shown at 120. A resource entry for each continuous time period may be generated as shown at 130. These resource entries may be stored, for example, in resource scheduling database 14. A request to schedule a resource may be proceed by processing circuitry 20, where the request includes a requested resource identifier, a date, a start time, a finish time, and a location, as shown at 140. A resource entry may be identified at 150 that corresponds to the request. The resource entry may be modified to remove the time period of the request at 160.

As described above, FIG. 12 illustrates a flowchart of a system, method, and computer program product according to example embodiments of the invention. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices 24 of a computing device 18 and executed by processing circuitry 20 in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks or steps of the flowcharts support combinations of means for performing the specified functions and combinations of steps for performing the specified functions. It will also be understood that one or more blocks of the flowcharts, and combinations of blocks in the flowcharts, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processing circuitry 20 may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A computing device comprising processing circuitry configured to:
generate a representation of a resource availability schedule comprising at least one resource entry, wherein each resource entry comprises a resource identification, a date, a location, a start time, and a finish time, and wherein the processing circuitry configured to generate the representation comprises processing circuitry configured to:
divide the availability for each resource for each date and location into at least one continuous time period of availability, wherein no continuous time period of availability for a resource is represented by more than one resource entry; and
generate a resource entry for each continuous time period;
process a request to schedule a resource, the request comprising a requested resource identifier, date, start time, finish time, and location;
identify a resource entry corresponding to the request; and
modify the resource entry to remove the time period of the request.

2. The computing device of claim 1, wherein in response to a request to schedule a resource comprising a start time equating to the start time of the resource entry corresponding to the request, the processing circuitry configured to modify the resource entry comprises processing circuitry configured to modify the resource entry start time to become the finish time of the request.

3. The computing device of claim 2, wherein in response to a request to schedule a resource comprising a finish time equating to the finish time of the resource entry corresponding to the request, the processing circuitry configured to modify the resource entry comprises processing circuitry configured to modify the resource entry finish time to become the start time of the request.

4. The computing device of claim 3, wherein in response to a request to schedule a resource comprising a start time that does not equate to the start time of the resource entry corresponding to the request, and the request comprises a finish time that does not equate to the finish time of the resource entry corresponding to the request, the processing circuitry configured to modify the resource entry comprises processing circuitry to divide the resource entry corresponding to the request into a first resource entry and a second resource entry, wherein the first resource entry comprises a start time equating to the start time of the resource entry corresponding to the request and a finish time equating to the start time of the request, and wherein the second resource entry comprises a start time equating to the finish time of the request and a finish time equating to the finish time of the resource entry corresponding to the request.

5. The computing device of claim 1, wherein in response to a request to cancel a scheduled event for a resource, the computing device further comprises processing circuitry configured to append a time period of the scheduled event to a resource entry for which the time period is continuous.

6. The computing device of claim 1, wherein the processing circuitry configured to process the request to schedule a resource comprises processing circuitry configured to receive a request comprising a resource identification, and at least one of a date range, a time duration, a time range, or acceptable locations, and the processing circuitry configured to process the request comprises processing circuitry configured to establish available time periods corresponding to the request.

7. The computing device of claim 6, further comprising processing circuitry configured to:
present the available time periods corresponding to the request;
receive a selection from the available time periods; and
process the selected request to schedule a resource for the selected time period.

8. A method comprising:
generating a representation of a resource availability schedule comprising at least one resource entry, wherein each resource entry comprises a resource identification, a date, a location, a start time, and a finish time, wherein generating the representation comprises:
dividing the availability for each resource for each date and location into at least one continuous time period of availability, wherein no continuous time period of availability for a resource is represented by more than one resource entry; and
generating a resource entry for each continuous time period;
processing a request to schedule a resource, the request comprising a requested resource identifier, date, start time, finish time, and location;
identifying a resource entry corresponding to the request; and
modifying the resource entry to remove the time period of the request.

9. The method of claim 8, wherein in response to a request to schedule a resource comprising a start time equating to the start time of the resource entry corresponding to the request, modifying the resource entry comprises modifying the resource entry start time to become the finish time of the request.

10. The method of claim 9, wherein in response to a request to schedule a resource comprising a finish time equating to the finish time of the resource entry corresponding to the request, modifying the resource entry comprises modifying the resource entry finish time to become the start time of the request.

11. The method of claim 10, wherein in response to a request to schedule a resource comprising a start time that does not equate to the start time of the resource entry corresponding to the request, and the request comprises a finish time that does not equate to the finish time of the resource entry corresponding to the request, modifying the resource entry comprises dividing the resource entry corresponding to the request into a first resource entry and a second resource entry, wherein the first resource entry comprises a start time equating to the start time of the resource entry corresponding to the request and a finish time equating to the start time of the request, and wherein the second resource entry comprises a start time equating to the finish time of the request and a finish time equating to the finish time of the resource entry corresponding to the request.

12. The method of claim 8, wherein in response to a request to cancel a scheduled event for a resource, appending a time period of the scheduled event to a resource entry for which the time period is continuous.

13. The method of claim 8, wherein processing the request to schedule a resource comprises receiving a request comprising a resource identification, and at least one of a date range, a time duration, a time range, or acceptable locations, and processing the request comprises establishing available time periods corresponding to the request.

14. The method of claim 13, further comprising:
causing presentation of the available time periods corresponding to the request;
receiving a selection from the available time periods; and
processing the selected request to schedule a resource for the selected time period.

15. A computer program product comprising a non-transitory computer readable storage medium having program code portions stored therein, the program code portions configured, upon execution, to:
generate a representation of a resource availability schedule comprising at least one resource entry, wherein each resource entry comprises a resource identification, a date, a location, a start time, and a finish time, and wherein the processing circuitry configured to generate the representation comprises processing circuitry configured to:
divide the availability for each resource for each date and location into at least one continuous time period of availability, wherein no continuous time period of availability for a resource is represented by more than one resource entry; and
generate a resource entry for each continuous time period;
process a request to schedule a resource, the request comprising a requested resource identifier, date, start time, finish time, and location;
identify a resource entry corresponding to the request; and
modify the resource entry to remove the time period of the request.

16. The computer program product of claim 15, wherein in response to a request to schedule a resource comprising a start time equating to the start time of the resource entry corresponding to the request, the program code portions configured to modify the resource entry comprise program code portions configured to modify the resource entry start time to become the finish time of the request.

17. The computer program product of claim 16, wherein in response to a request to schedule a resource comprising a finish time equating to the finish time of the resource entry corresponding to the request, the program code instructions configured to modify the resource entry comprise program code instructions configured to modify the resource entry finish time to become the start time of the request.

18. The computer program product of claim 17, wherein in response to a request to schedule a resource comprising a start time that does not equate to the start time of the resource entry corresponding to the request, and the request comprises a finish time that does not equate to the finish time of the resource entry corresponding to the request, the program code instructions configured to modify the resource entry comprise program code instructions to divide the resource entry corresponding to the request into a first resource entry and a second resource entry, wherein the first resource entry comprises a start time equating to the start time of the resource entry corresponding to the request and a finish time equating to the start time of the request, and wherein the second resource entry comprises a start time equating to the finish time of the request and a finish time equating to the finish time of the resource entry corresponding to the request.

19. The computer program product of claim 15, wherein in response to a request to cancel a scheduled event for a resource, the computer program product further comprises program code instructions configured to append a time period of the scheduled event to a resource entry for which the time period is continuous.

20. The computer program product of claim 15, wherein the program code instructions configured to process the request to schedule a resource comprise program code instructions configured to receive a request comprising a resource identification, and at least one of a date range, a time duration, a time range, or acceptable locations, and the program code instructions configured to process the request comprise program code instructions configured to establish available time periods corresponding to the request.
